(19) United States
(12) Patent Application Publication
(10) Pub. No.: US 2026/0199929 A1
(43) Pub. Date: Jul. 16, 2026

(54) MANUFACTURING METHOD FOR OPTICAL FIBER TAPE CORE WIRE

(71) Applicant: SWCC Corporation, Kanagawa (JP)

(72) Inventors: Takeshiro NAGAI, Kanagawa (JP); Takehiko YAMAMOTO, Kanagawa (JP); Hiroyuki TOMONARI, Kanagawa (JP); Wataru NORO, Kanagawa (JP)

(21) Appl. No.: 19/560,495

(22) Filed: Mar. 9, 2026

Related U.S. Application Data
(62) Division of application No. 18/880,045, filed on Jul. 18, 2024.

(51) Int. Cl. B05C 11/04

(52) U.S. Cl. CPC B05C 11/04

(57) ABSTRACT

The present invention relates to a manufacturing method for an optical fiber tape core wire including a plurality of single-core coated optical fibers disposed in parallel and partially coupled, the manufacturing method comprising: applying an uncured resin to the plurality of single-core coated optical fibers disposed in parallel; partially removing an applied uncured resin between the single-core coated optical fibers adjacent to each other of the plurality of single-core coated optical fibers under an atmosphere that inhibits generation of bubbles in the uncured resin; and curing the uncured resin that remains on the plurality of single-core coated optical fibers without being removed.

### CROSS REFERENCE TO RELATED APPLICATIONS

This application is a divisional of U.S. Patent Application No. 18/880,045, filed on December 30, 2024, which is National Stage Application of International Application No. PCT/JP2024/025806, filed on July 18, 2024, the disclosure of which, including the specification, drawings and abstract, is incorporated herein by reference in their entirety.

### TECHNICAL FIELD

The present invention relates to a manufacturing method for an optical fiber tape core wire.

### BACKGROUND ART

In recent years, the spread of the IoT (Internet of Things), the full-scale commercialization of 5G, the automated driving of automobiles, and the like have led to a dramatic increase in data traffic. In response to this increase, there is a growing demand for the development and construction of high-speed, large-capacity optical fiber communication networks. In order to economically realize the development and construction of a high-speed, large-capacity optical fiber communication network, it is important to accommodate more single-core coated optical fibers (optical fibers) in existing ducts. When a large number of single-core coated optical fibers are accommodated in an existing duct as described above, a rollable ribbon (optical fiber tape core wire) in which single-core coated optical fibers are intermittently coupled is used from the viewpoint of workability in wiring installation work (see, for example, PTL 1).

PTL 1 discloses a manufacturing method for such an optical fiber tape core wire. In this manufacturing method, a UV-curable resin is applied to a plurality of single-core coated optical fibers that are arranged in parallel, the applied uncured UV-curable resin is partially removed, and the resin that remains on the plurality of optical fibers without being removed is cured with UV to obtain an optical fiber tape core wire. Here, the removal part for partially removing the applied uncured resin includes a rotary blade having a recess portion (notch). By rotating the rotary blade having the notch, it is possible to partially remove the UV-curable resin.

### Citation List

### Patent Literature

PTL 1

Japanese Patent Application Laid-Open No.2010-33010

### SUMMARY OF INVENTION

### Technical Problem

However, when removing the uncured resin as disclosed in PTL 1, air may enter the uncured resin, thus generating bubbles. When the uncured resin is cured with such bubbles generated, voids may be formed in the cured resin, and the strength of the optical fiber tape core wire may be reduced.

An object of the present invention is to provide a manufacturing method for an optical fiber tape core wire that can suppress generation of bubbles in an uncured resin during the removal of the applied uncured resin.

### Solution to Problem

To solve the above described problem, an aspect of the present disclosure provides a manufacturing method for an optical fiber tape core wire including a plurality of single-core coated optical fibers disposed in parallel and partially coupled, the method including: applying an uncured resin to the plurality of single-core coated optical fibers disposed in parallel; partially removing an applied uncured resin between the single-core coated optical fibers adjacent to each other of the plurality of single-core coated optical fibers under an atmosphere that inhibits generation of bubbles in the uncured resin; and curing the uncured resin that remains on the plurality of single-core coated optical fibers without being removed.

### Advantageous Effects of Invention

According to the present invention, it is possible to provide a manufacturing method for an optical fiber tape core wire that can suppress generation of bubbles in an uncured resin during the removal of the applied uncured resin.

### BRIEF DESCRIPTION OF DRAWINGS

FIGS. 1A to 1C are schematic views illustrating an optical fiber tape core wire;

FIG. 2A is a diagram illustrating a schematic configuration of a manufacturing apparatus for an optical fiber tape core wire, and FIG. 2B is a cross-sectional view of a removal part; and

FIG. 3 is a flowchart of a manufacturing method for an optical fiber tape core wire.

### DESCRIPTION OF EMBODIMENTS

Hereinafter, a manufacturing apparatus for an optical fiber tape core wire and a manufacturing method for an optical fiber tape core wire according to a preferred embodiment of the present invention will be described. In the present specification, with respect to the description of "to" indicating a numerical range, the lower limit value and the upper limit value are included in the numerical range. First, the following describes an optical fiber tape core wire to be manufactured, and then describes a manufacturing apparatus for the optical fiber tape core wire and a manufacturing method for the optical fiber tape core wire.

### Configuration of Optical Fiber Tape Core Wire

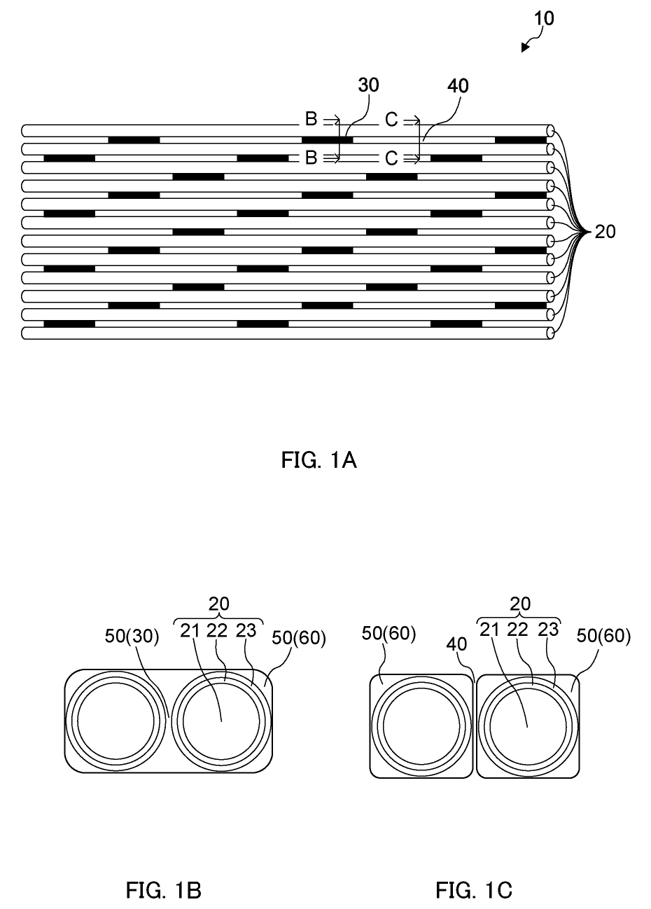

FIG. 1A is a schematic plan view of optical fiber tape core wire 10, FIG. 1B is a cross-sectional view taken along line B-B in FIG. 1A, and FIG. 1C is a cross-sectional view taken along line C-C in FIG. 1A. In FIG. 1, coupling part 30 is illustrated in black to distinguish between coupling part 30 and separation part 40, and ensure clarity in illustration.

As illustrated in FIG. 1A, in optical fiber tape core wire 10, the plurality of single-core coated optical fibers 20 are disposed in parallel. Coupling part 30 and separation part 40 are intermittently provided between the plurality of single-core coated optical fibers 20 disposed in parallel. Coupling part 30 is a part in which the UV-curable resin is cured, and separation part 40 is a part provided with no cured resin. As illustrated in FIG. 1A, optical fiber tape core wire 10, which includes coupling part 30 and separation part 40 in an intermittent manner, is easily foldable in the width direction, enabling bundling and increasing the density of single-core coated optical fiber 20.

FIG. 1B is a cross-sectional view taken along line B-B in FIG. 1A, that is, at coupling part 30, and FIG. 1C is a cross-sectional view taken along line C-C in FIG. 1A, that is, at separation part 40.

As can be seen from FIGS. 1B and 1C, single-core coated optical fiber 20 includes optical fiber strand 21, primary coating layer 22, and secondary coating layer 23 from the center thereof toward the outside. As illustrated in FIGS. 1B and 1C, cured resin 50 is present around two single-core coated optical fibers 20. Cured resin 50 functions as tape layer 60 on the surface of optical fiber tape core wire 10, and functions as coupling part 30 between two single-core coated optical fibers 20.

As can be seen in FIG. 1C, in the cross section of separation part 40, cured resin 50 is present around each of the two single-core coated optical fibers 20, but cured resin 50 is not present between the two single-core coated optical fibers 20, and this forms separation part 40.

### Manufacturing Apparatus for Optical Fiber Tape Core Wire, and Manufacturing Method for Optical Fiber Tape Core Wire

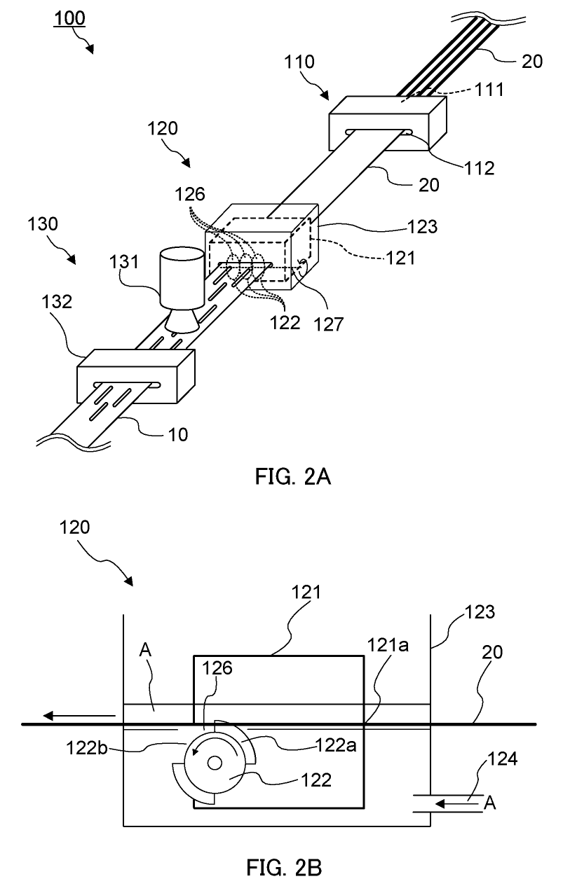

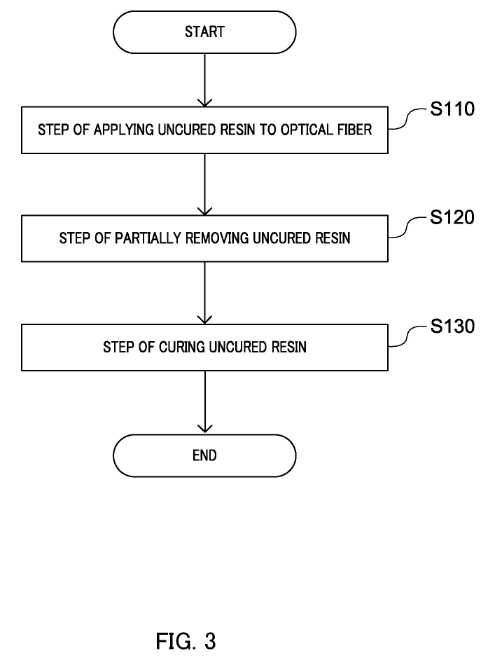

FIG. 2A is a schematic perspective view of manufacturing apparatus 100 for an optical fiber tape core wire, FIG. 2B is a partial longitudinal cross-sectional view of FIG. 2A, and FIG. 3 is a flowchart of a manufacturing method for an optical fiber tape core wire.

As illustrated in FIG. 2A, manufacturing apparatus 100 for an optical fiber tape core wire includes coating part 110 for applying an uncured resin, removal part 120 for partially removing the applied uncured resin, and curing part 130 for curing the uncured resin that remains without being removed. In manufacturing apparatus 100 for optical fiber tape core wires, coating part 110, removal part 120, and curing part 130 are disposed in this order along the passing direction of the plurality of single-core coated optical fibers 20.

As illustrated in FIG. 3, a step (S110) of applying the uncured resin to single-core coated optical fiber 20 with coating part 110, a step (S120) of partially removing the uncured resin with removal part 120, and a step (S130) of curing the uncured resin with curing part 130 are performed. Note that in the present embodiment, the uncured resin is a UV-curable resin prior to curing. Hereinafter, each will be described.

Coating part 110 receives the plurality of single-core coated optical fibers 20 passing in parallel and applies an uncured resin to coat the periphery thereof. Coating part 110 includes inlet wire part 111 for receiving the plurality of single-core coated optical fibers 20, and outlet wire part 112 for ejecting the plurality of single-core coated optical fibers 20 on which an uncured resin has been applied. The plurality of single-core coated optical fibers 20 drawn out from outlet wire part 112 are entirely covered with an uncured resin and have a tape shape.

Removal part 120 partially removes an applied uncured resin to the plurality of single-core coated optical fibers 20 between adjacent single-core coated optical fibers 20 so as to provide optical fiber tape core wire 10 having intermittent coupling part 30 (see FIG. 1A).

FIG. 2B is a cross-sectional view along the length direction of optical fiber tape core wire 10, illustrating details of removal part 120. As illustrated in FIG. 2B, removal part 120 includes dividing die 121, rotary blade 122 disposed in dividing die 121, gas filling part 123, and gas supply part 124 for supplying gas to gas filling part 123.

As illustrated in FIG. 2A, dividing die 121 includes the plurality of rotary blades 122 arranged in the width direction of optical fiber tape core wire 10, and the plurality of slits 126, corresponding to each rotary blade 122, arranged in the width direction of optical fiber tape core wire 10. As illustrated in FIG. 2B, rotary blade 122 includes blade part 122a and notch part 122b. Blade part 122a can protrude from slit 126 when rotary blade 122 rotates, but notch part 122b cannot protrude from slit 126 when rotary blade 122 rotates. Thus, when rotary blade 122 rotates, blade part 122a intermittently protrudes from slit 126 so as to partially (intermittently) remove the uncured resin between the plurality of single-core coated optical fibers 20 passing over slit 126. On the other hand, when notch part 122b is positioned at slit 126 with blade part 122a not protruded, the uncured resin is not removed and the uncured resin remains partially (intermittently) on the plurality of single-core coated optical fibers 20. Note that in the present embodiment, rotary blade 122 rotates to follow the passing direction of the plurality of single-core coated optical fibers 20.

As illustrated in FIG. 2B, blade part 122a and notch part 122b in rotary blade 122 are disposed at the same distance in the radial direction from the rotation center of rotary blade 122. The circumferential length of blade part 122a and notch part 122b is a factor that determines the length of coupling part 30 and the separation part. Note that the method for removing the uncured resin is not limited to the above-described method using rotary blade 122. The uncured resin may be mechanically removed by a member that moves up and down, for example.

When the above-described uncured resin is removed in the air, air may enter the uncured resin and generate bubbles, thus reducing the strength of optical fiber tape core wire 10. According to manufacturing apparatus 100 and the manufacturing method for an optical fiber tape core wire of the present embodiment, the removal of the uncured resin is performed in a bubble generation suppression atmosphere, thereby suppressing the generation of bubbles.

Specifically, in the present embodiment, as illustrated in FIG. 2B, the above-described dividing die 121 is disposed in gas filling part 123, and gas A capable of suppressing the generation of bubbles supplied from gas supply part 124 (hereinafter, also simply referred to as gas A) is supplied to gas filling part 123. Thus, the concentration of air is reduced, and the generation of bubbles is suppressed even if the uncured resin is mechanically removed by rotary blade 122.

Preferably, gas filling part 123 is configured to fill gas A around the plurality of single-core coated optical fibers 20 passing in dividing die 121. More preferably, gas filling part 123 is configured to fill gas A around blade part 122a of rotary blade 122. For example, in a case where the density of gas A is higher than the density of air, gas filling part 123 may be a box with an opening at the upper portion, as illustrated in FIG. 2B. In this case, preferably, gas filling part 123 is configured to fill gas A up to a position higher than the uncured resin of the plurality of single-core coated optical fibers 20 passing in dividing die 121. More preferably, gas filling part 123 is configured to be capable of filling gas A up to a position higher than the maximum height position that blade part 122a of rotary blade 122 can reach.

Bubbles may be generated not only during the removal of the uncured resin, but also when the plurality of single-core coated optical fibers 20 are introduced into inlet wire part 121a of dividing die 121. For this reason, from the viewpoint of suppressing the generation of bubbles, it is preferable that gas filling part 123 be configured to fill the periphery of inlet wire part 121a of dividing die 121 with gas. In a case where the density of gas A is heavier than the density of air, gas filling part 123 is preferably configured to be capable of filling gas up to a position higher than the height of inlet wire part 121a of dividing die 121.

Gas A for the bubble generation suppression atmosphere is not particularly limited as long as it can suppress the generation of bubbles. In a case where the atmosphere is air, it is not possible to suppress the generation of bubbles as described above. Here, air is a gas mainly composed of oxygen and nitrogen. Accordingly, it is considered that a gas containing a large amount of oxygen and nitrogen is likely to generate bubbles. In view of this, it is considered that the gas for the bubble generation suppression atmosphere is preferably a gas containing oxygen or nitrogen at a concentration lower than that in air.

The reason why air is likely to generate bubbles is presumed as follows. Specifically, it is presumed that oxygen and nitrogen in the air have a low solubility or a low diffusivity in the uncured resin, and thus are likely to generate bubbles. Accordingly, it is considered that gas A for the bubble generation suppression atmosphere preferably has a higher solubility in the uncured resin than oxygen or nitrogen, or a higher diffusivity in the uncured resin than oxygen or nitrogen. In this manner, it is presumed that even if gas A enters the uncured resin, it will dissolve in the uncured resin without generating bubbles. Alternatively, if it does enter, it will diffuse and be ejected to the outside of the uncured resin without generating bubbles.

Further, the density of gas A is preferably higher than the density of air. That is, gas A is preferably heavier than air. Thus, even if the upper portion of gas filling part 123 is open, it is possible to suppress gas A from remaining in gas filling part 123 and diffusing into the air, thereby making it easier to maintain the bubble generation suppression atmosphere. Examples of such gas A include carbon dioxide.

In the present embodiment, the bubble generation suppression atmosphere is a carbon dioxide atmosphere. Carbon dioxide is preferred because it is considered to be heavier than air and to have a high solubility in uncured resin. The concentration of carbon dioxide in the carbon dioxide atmosphere may be any concentration that can suppress the generation of bubbles. The concentration of carbon dioxide in the carbon dioxide atmosphere is, for example, a concentration in which carbon dioxide is the main component, and is, for example, 90% or more.

Further, gas A for the bubble generation suppression atmosphere is preferably one that is highly safe for the human body and is non-combustible.

Note that the method for creating a bubble generation suppression atmosphere is not limited to the above-described method using gas filling part 123. For example, to create a bubble generation suppression atmosphere, gas A may be blown to a portion from which the uncured resin is removed and to inlet wire part 121a of dividing die 121.

The configuration of gas supply part 124 is not particularly limited as long as gas A can be supplied into gas filling part 123. In the present embodiment, gas supply part 124 is disposed at the lower portion of gas filling part 123.

Curing part 130 cures the uncured resin that remains without being removed by removal part 120. Curing part 130 is not particularly limited as long as it can exhibit this function. In the present embodiment, curing part 130 includes first light irradiation part 131 disposed upstream and second light irradiation part 132 disposed downstream. First light irradiation part 131 applies light onto the uncured resin to semi-cure the uncured resin. Second light irradiation part 132 further emits light to completely cure the semi-cured resin. In the present embodiment, the integrated irradiation amount of first light irradiation part 131 is adjusted to be smaller, and the integrated irradiation amount of second light irradiation part 132 is adjusted to be larger. Note that the light to be emitted is ultraviolet (UV).

### Effects

According to the present embodiment, the voids in the cured resin are reduced by reducing the bubbles in the uncured resin. This improves the adhesive strength of the coupling part of the optical fiber tape core wire. Further, according to the present embodiment, it is possible to prevent the occurrence of blisters (water ingress into the cured resin) during the reliability test (hot water test) of the optical fiber tape core wire, and to achieve improvement in terms of the increase in optical loss during the test and the long-term reliability of the optical fiber (to suppress the optical fiber tape core wire from being broken).

### INDUSTRIAL APPLICABILITY

The manufacturing apparatus for an optical fiber tape core wire according to the present invention is useful, for example, in the manufacturing of optical fiber tape core wires used in high-speed, large-capacity optical fiber communication networks.

### Reference Signs List

10 Optical fiber tape core wire

20 Single-core coated optical fiber

21 Optical fiber strand

22 Primary coating layer

23 Secondary coating layer

30 Coupling part

40 Separation part

50 Cured resin

60 Tape layer

100 Manufacturing apparatus for optical fiber tape core wire

110 Coating part

111, 121a Inlet wire part

112 Outlet wire part

120 Removal part

121 Dividing die

122 Rotary blade

122a Blade part

122b Notch part

123 Gas filling part

124 Gas supply part

126 Slit

130 Curing part

131 First light irradiation part

132 Second light irradiation part

1. A manufacturing method for an optical fiber tape core wire including a plurality of single-core coated optical fibers disposed in parallel and partially coupled, the manufacturing method comprising:
applying an uncured resin to the plurality of single-core coated optical fibers disposed in parallel;
partially removing an applied uncured resin between the single-core coated optical fibers adjacent to each other of the plurality of single-core coated optical fibers under an atmosphere that inhibits generation of bubbles in the uncured resin; and
curing the uncured resin that remains on the plurality of single-core coated optical fibers without being removed.

2. The manufacturing method for the optical fiber tape core wire according to claim 1, wherein in the atmosphere, a concentration of oxygen or nitrogen is lower than a concentration of oxygen or nitrogen in air.

3. The manufacturing method for the optical fiber tape core wire according to claim 1, wherein the atmosphere is a carbon dioxide atmosphere.

4. The manufacturing method for the optical fiber tape core wire according to claim 1, wherein in the partially removing, the uncured resin is removed with a rotating rotary blade.
